(19) United States
(12) Patent Application Publication
(10) Pub. No.: US 2026/0339712 A1
(43) Pub. Date: Oct. 29, 2026

(54) MEMORY MANAGEMENT METHOD AND APPARATUS, COMPUTER DEVICE, AND STORAGE MEDIUM

(71) Applicant: CLOUD INTELLIGENCE ASSETS HOLDING (SINGAPORE) PRIVATE LIMITED, Singapore (SG)

(72) Inventor: Hao ZHENG, Beijing (CN)

(21) Appl. No.: 19/116,017

(22) PCT Filed: Oct. 9, 2023
(86) PCT No.: PCT/CN2023/123475

§ 371 Date: Mar. 27, 2025

(30) Foreign Application Priority Data
Oct. 12, 2022 (CN) 202211248341.1

(51) Int. Cl. G06F 9/50

(52) U.S. Cl. CPC G06F 9/5016; G06F 9/5022; G06F 9/5044

(57) ABSTRACT

Provided are a memory management method and apparatus, a computer device and a storage medium, where a memory includes a plurality of memory sections, each memory section is divided into a plurality of memory segments; the memory is used to store total metadata and section metadata corresponding to each allocated memory section; the section metadata includes allocation status information of each memory segment in the allocated memory section; the total metadata includes quantity information of an unallocated memory segment in each allocated memory section; the method includes: determining, according to the total metadata and the section metadata, a target memory segment whose status needs to be adjusted in response to a memory adjustment request; adjusting allocation status of the target memory segment based on a memory adjustment type corresponding to the memory adjustment request; and after adjusting the allocation status of the target memory segment, updating allocation status information of section metadata of a target memory section to which the target memory segment belongs, and updating quantity information of an unallocated memory segment in the target memory section in the total metadata.

### CROSS-REFERENCE TO RELATED APPLICATIONS

This application is a National Stage of International Application No. PCT/CN 2023/123475, and filed on Oct. 9, 2023, which claims priority to Chinese Patent Application No. 202211248341.1, filed with the China National Intellectual Property Administration on Oct. 12, 2022 and entitled “MEMORY MANAGEMENT METHOD AND APPARATUS, COMPUTER DEVICE, AND STORAGE MEDIUM”. The disclosures of the aforementioned applications are hereby incorporated by reference in their entireties.

### TECHNICAL FIELD

The description relates to the field of computer technologies and, in particular, to a memory management method and apparatus, a computer device, and a storage medium.

### BACKGROUND

In a traditional memory management solution, memory is divided into a plurality of memory pages, and metadata (such as a struct page) needs to be created for each page to manage each page. Since the memory page is usually small (e.g., 4k bytes), for example, for each memory page with 4k bytes, it needs 64 bytes for metadata of each memory page; and in a large memory scenario, storing metadata occupies a large amount of memory space, causing a large number of metadata occupying the memory.

In other solutions, in order to avoid a large number of metadata occupying the memory, a larger granularity is used as a management unit to manage the memory, such as dividing the memory into memory sections with 2 m size for management. However, each memory section may not fully store data at a larger management granularity, causing wastage of internal storage space within the memory section. In addition, for a scenario that needs a small section of memory, such as a scenario that storing compressed memory data, there is also a need to manage the memory sections at a smaller granularity. Based on this, how to avoid memory waste at a large management granularity is an urgent technical problem.

### SUMMARY

To overcome problems existing in related technologies, embodiments of the specification provide a memory management method and apparatus, and a computer device.

According to a first aspect of an embodiment of the specification, a memory management method is provided, where a memory includes a plurality of memory sections, each memory section is divided into a plurality of memory segments; the memory is used to store total metadata and section metadata corresponding to each allocated memory section;
the section metadata includes allocation status information of each memory segment in the allocated memory section;
the total metadata includes quantity information of an unallocated memory segment in each allocated memory section;
the method includes:
determining, according to the total metadata and the section metadata, a target memory segment with allocation status needing to be adjusted in response to a memory adjustment request;
adjusting allocation status of the target memory segment based on a memory adjustment type corresponding to the memory adjustment request;
after adjusting the allocation status of the target memory segment, updating allocation status information of section metadata of a target memory section to which the target memory segment belongs, and updating quantity information of an unallocated memory segment in the target memory section in the total metadata.

According to a second aspect of an embodiment of the specification, a memory management apparatus is provided, where a memory includes a plurality of memory sections, each memory section is divided into a plurality of memory segments;
the memory is used to store total metadata and section metadata corresponding to each allocated memory section;
the section metadata includes allocation status information of each memory segment in the allocated memory section;
the total metadata includes quantity information of an unallocated memory segment in each allocated memory section;
the apparatus includes:
a determining module, configured to determine, according to the total metadata and the section metadata, a target memory segment with allocation status needing to be adjusted in response to a memory adjustment request;
an adjusting module, configured to adjust allocation status of the target memory segment based on a memory adjustment type corresponding to the memory adjustment request;
an updating module, configured to, after adjusting the allocation status of the target memory segment, update allocation status information of section metadata of a target memory section to which the target memory segment belongs, and update quantity information of an unallocated memory segment in the target memory section in the total metadata.

According to a third aspect of an embodiment of the specification, a computer device is provided, including a memory, a processor, and a computer program stored in the memory and running in the processor, where when executing the computer program, the processor implements steps of the method embodiment described in the first aspect above.

According to a fourth aspect of an embodiment of the specification, a computer program product is provided, including a computer program which, when executed by a processor, implements steps of the method embodiment described in the first aspect above.

According to a fifth aspect of an embodiment of the specification, a computer readable storage medium is provided, storing a computer program which, when executed by a processor, implements steps of the method embodiment described in the first aspect above.

The technical solutions provided by the embodiments of the specification may include the following beneficial effects.

In embodiments of the specification, the memory includes a plurality of memory sections, and each memory section is divided into a plurality of memory segments. Therefore, the memory section can be designed with a larger granularity to reduce the occupation of section metadata in the memory section; in addition, specific management can be carried out on the memory segments in the memory section. This embodiment designs two layers of metadata, including total metadata and section metadata of each allocated memory section. The section metadata includes allocation status information of each memory segment in the allocated memory section, which is used to determine an available memory segment for allocation in the allocated memory section. The total metadata includes quantity information of an unallocated memory segment in each allocated memory section, which is used to determine an allocatable memory section in the memory. When there is a memory adjustment request, a target memory segment whose allocation status needs to be adjusted can be determined; and after adjusting the allocation status of the target memory segment, allocation status information of section metadata of the target memory section to which the target memory segment belongs is updated, and the quantity information of the unallocated memory segment in the target memory section in the total metadata is updated. Therefore, the allocation of the memory segments can be achieved, the waste of remaining space in the memory section with a large granularity is reduced, and the management for the memory section at a smaller granularity can be achieved.

It should be understood that the above general description and the detailed description in the following text are only exemplary and explanatory, and cannot limit the specification.

### BRIEF DESCRIPTION OF DRAWINGS

The accompanying drawings are incorporated into the specification and form a part of the specification, illustrate embodiments conforming to the specification, and are used in conjunction with the specification to explain the principles of the specification.

FIGS. 1A and 1B are schematic diagrams of a memory architecture shown in the specification according to an exemplary embodiment.

FIG. 2A is a schematic diagram of dividing a memory section into memory segments shown in the specification according to an exemplary embodiment.

FIG. 2B is a schematic diagram of a single linked list shown in the specification according to an exemplary embodiment.

FIG. 2C is a schematic diagram of a double linked list shown in the specification according to an exemplary embodiment.

FIG. 2D is a schematic diagram of two double linked lists shown in the specification according to an exemplary embodiment.

FIG. 2E is a schematic diagram of a linked list array shown in the specification according to an exemplary embodiment.

FIG. 2F is a schematic diagram of total metadata shown in the specification according to an exemplary embodiment.

FIGS. 2G to 2J are schematic diagrams of memory management shown in the specification according to an exemplary embodiment, respectively.

FIG. 3 is a block diagram of a computer device where a memory management apparatus is located shown in the specification according to an exemplary embodiment.

FIG. 4 is a block diagram of a memory management apparatus shown in the specification according to an exemplary embodiment.

### DESCRIPTION OF EMBODIMENTS

Exemplary embodiments will be described in detail here, examples of which are represented in the accompanying drawings. When referring to the accompanying drawings, unless otherwise indicated, the same numbers in different accompanying drawings represent the same or similar elements. The embodiments described in the following exemplary embodiments do not represent all embodiments consistent with the specification. On the contrary, they are only examples of apparatuses and methods consistent with some aspects of the specification as described in the appended claims.

Terms used in the specification are for the purpose of describing specific embodiments only and are not intended to limit the specification. The singular forms of “a/an”, “said”, and “the” used in the specification and the appended claims are also intended to include the majority forms, unless the context clearly indicating other meanings. It should also be understood that the term “and/or” used herein refers to and includes any or all possible combinations of one or more associated listed items.

It should be understood that although the terms first, second, third, etc., may be used to describe various pieces of information in the specification, such information should not be limited to these terms. These terms are only used to distinguish the same type of information from each other. For example, without departing from the scope of the specification, the first information may also be referred to as the second information, and similarly, the second information may also be referred to as the first information. Depending on the context, the word “if” used here can be interpreted as “at the time . . . ” or “when . . . ” or “in response to determining . . . ” .

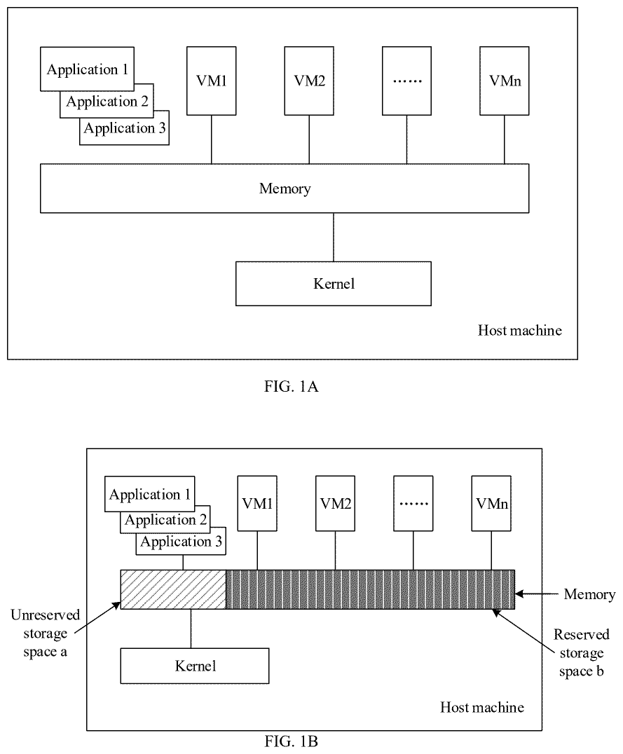

In the field of memory management, metadata of memory refers to data that records status information of each management unit (such as a memory page or a memory section) of the memory to facilitate the memory management. Based on specific management needs, many types of status information can be recorded in the metadata. It can be understood that metadata is stored in the memory during the operation of the computer device. As mentioned in BACKGROUND, when the management granularity of the memory is small, it can result in a large number of metadata occupying the memory. For example, in scenarios such as virtual machines, the overhead of the memory management can be high. As described in FIG. 1A, it is a schematic diagram of running a virtual machine in a host machine (Host) shown in the specification according to an exemplary embodiment.

The host machine in this embodiment refers to a physical computer used for installing virtual machine software, and the host machine is a concept relative to a virtual machine.

The virtual machine of this embodiment refers to a complete computer system with a complete hardware system function that is simulated through software and runs in a completely isolated environment. The virtual machine can perform tasks that the physical computer can accomplish. When creating a virtual machine in a computer, it is necessary to use a part of a hard disk and memory capacity of the physical machine as a hard disk and memory capacity of the virtual machine. Each virtual machine has an independent operating system that can be operated on like using a physical machine. Common virtual machine software includes but is not limited to VMware (VMWare ACE), Virtual Box, Virtual PC, or KVM (Kernel-based Virtual Machine), which can virtualize a plurality of computers in a physical machine system.

In conjunction with FIG. 1A, it is shown that a plurality of virtual machines VM1, VM2, . . . VMn can run in a host machine HOST, the memory used by which comes from the memory of the Host, while the kernel of the Host as well as other applications (e.g., Applications 1 to 3 in the figure) in the Host also may use the above memory. This will result in competition between the memory used by the kernel and the application and the memory used by the virtual machine in the process of running, causing uncertainty in the sellable memory of the host machine, especially in the case of severe memory constraints, this may also result in the virtual machine memory being swapped out or even the virtual machine being unusable, thereby affecting system performance and stability.

Based on this, a memory allocation architecture with reserved memory can be adopted. As described in FIG. 1B, it is a schematic diagram of a reserved memory scenario shown in the specification according to an exemplary embodiment. In this architecture, the memory of the host machine includes two storage spaces, for example, FIG. 1B illustrates two storage spaces of the memory, including an unreserved storage space a for a kernel (padded with diagonal lines in the figure) and a reserved storage space b for a virtual machine (padded with vertical lines and greyscale in the figure), with different padding methods. That is to say, the unreserved storage space a is used for the kernel in the figure, and an application running in the operating system (such as applications 1 to 3 in the example in the figure) can use the unreserved storage space a. And the reserved storage space b can be used by the virtual machine (VM), such as n virtual machines from VM1 to VMn shown in the figure. Two storage spaces can adopt different management granularities, that is, the division manner of the memory can be different. For the convenience of illustration in FIG. 1B, the two storage spaces are illustrated in a continuous manner. It can be understood that in a practical application, two storage spaces can be discontinuous.

The reserved memory space occupies most of the memory and is not available to the kernel of the host machine. A reserved memory module can be inserted into the kernel of the operating system specifically for management. In order to facilitate the management of this series of memory while avoiding a large amount of metadata occupying the memory, and considering that memory allocated to the virtual machine often at least starts from hundreds of MB (MByte, megabyte), thus, the reserved memory module usually manages the reserved memory with a larger granularity as a management unit, for example, the reserved memory is divided into memory sections (ms) with a size of 2 MB or the like for management. In some scenarios, large memory is also commonly used, other granularities, such as 1 GB (GigaByte), are optional.

However, each memory section may not fully store data at a larger management granularity, causing wastage of internal storage space within the memory section. In addition, in a memory compression scenario, the compressed data is also smaller than the size of the memory section. Based on this, how to avoid memory waste at a large management granularity and efficiently manage the internal of the memory section is an urgent technical problem.

Based on this, an embodiment of the specification provides a memory management method, where a memory includes a plurality of memory sections, each memory section is divided into a plurality of memory segments. Therefore, the memory section can be designed with a larger granularity to reduce the occupation of section metadata in the memory section; in addition, specific management can be carried out on the memory segments in the memory section. This embodiment designs two layers of metadata, on the basic of the section metadata of each allocated memory section, it also includes total metadata. The section metadata includes allocation status information of each memory segment in the allocated memory section, which is used to determine an available memory segment for allocation in the allocated memory section. The total metadata includes quantity information of an unallocated memory segment in each allocated memory section, which is used to determine an allocatable memory section in the memory. When there is a memory adjustment request, a target memory segment whose allocation status needs to be adjusted can be determined; and after adjusting the allocation status of the target memory segment, allocation status information of section metadata of the target memory section to which the target memory segment belongs is updated, and the quantity information of the unallocated memory segment in the target memory section in the total metadata is updated. Therefore, the allocation of the memory segments can be achieved, and the waste of remaining space in the memory section with a large granularity is reduced. Next, a detailed explanation of this embodiment will be provided.

The memory of this embodiment includes a plurality of memory sections, where each memory section is divided into a plurality of memory segments. The size of the memory section can be flexibly configured according to needs, such as 2 MB or 1 GB mentioned above, and this embodiment does not limit this. The memory sections can be contiguous or discontinuous.

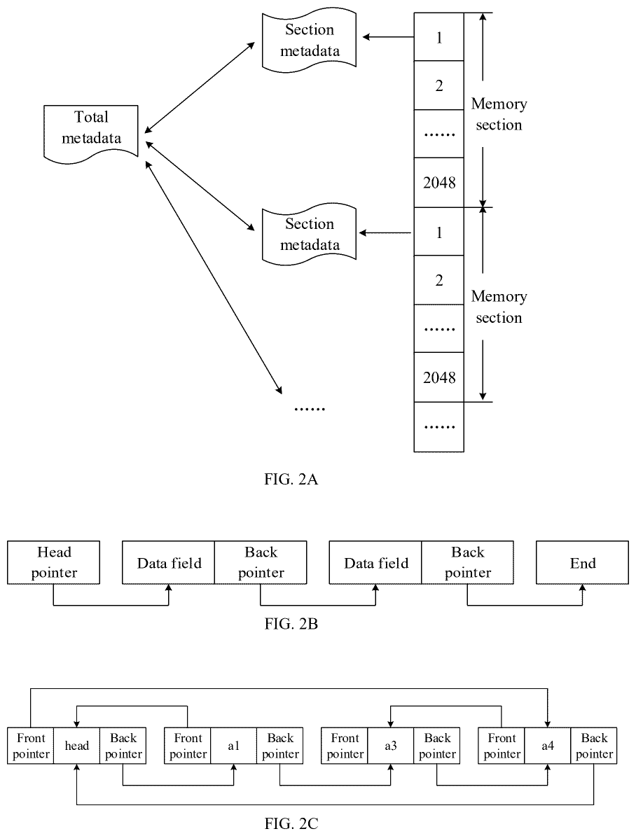

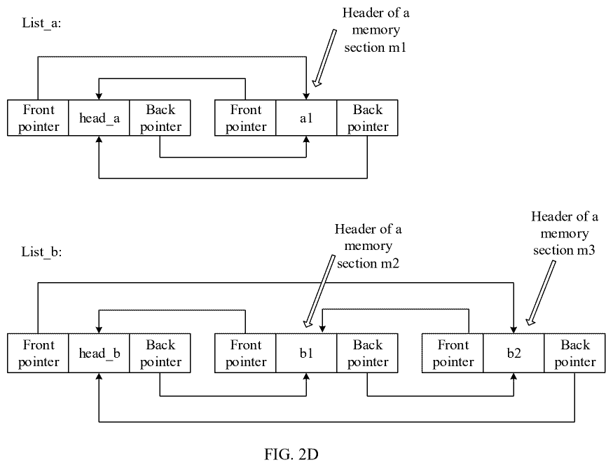

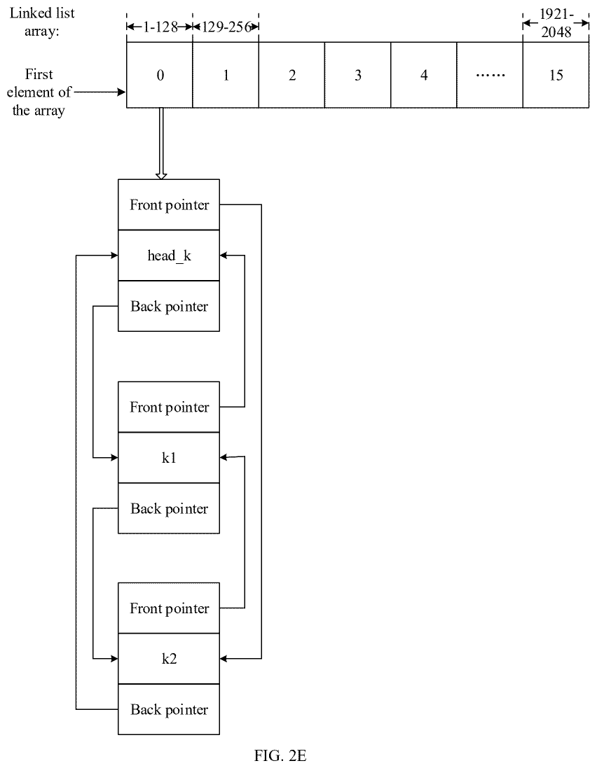

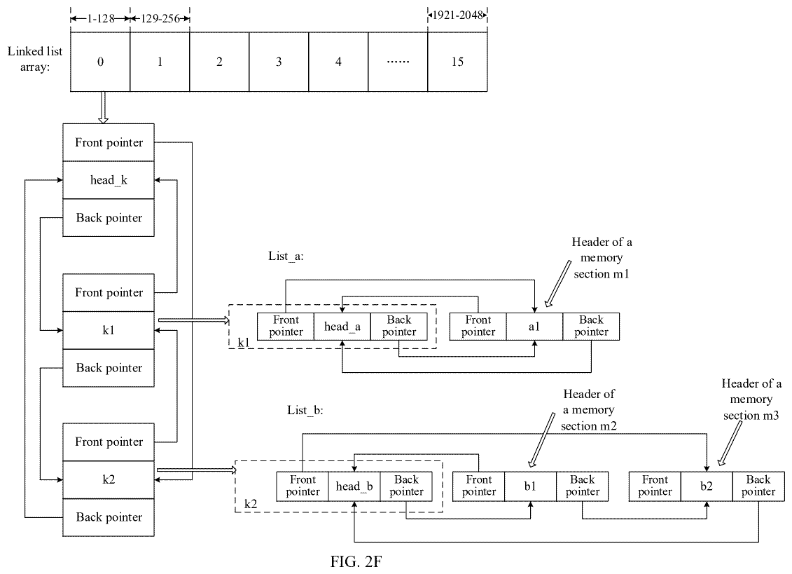

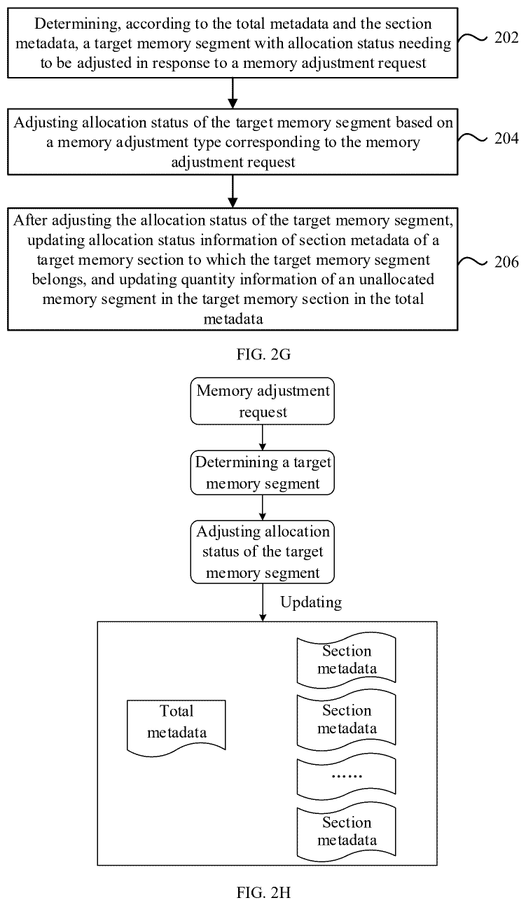

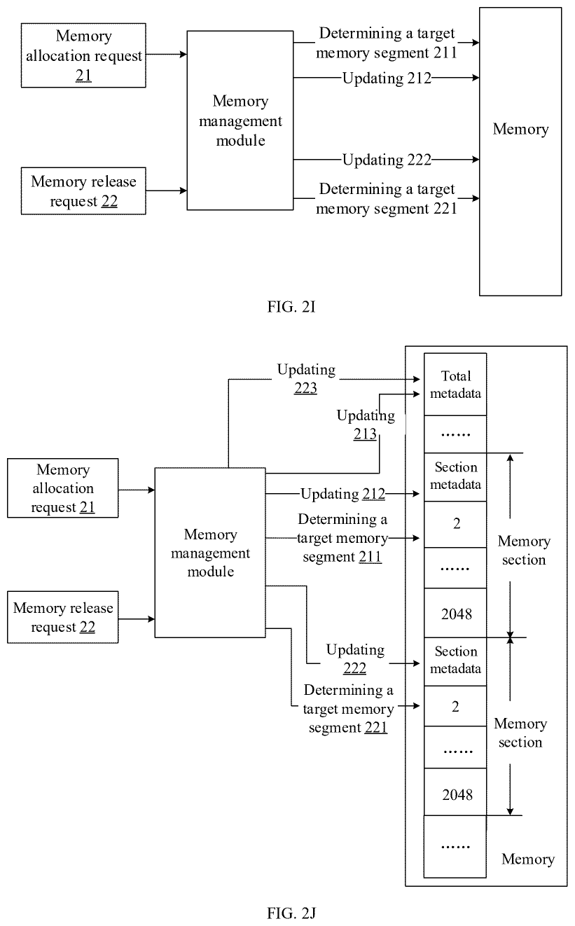

As shown in FIG. 2A, which shows each memory section being divided into a plurality of memory segment in the specification according to an embodiment, and the size of the memory segment can be flexibly configured as needed. This embodiment is not limited to this. Exemplarily, taking a 2 MB memory section as an example, it can be divided into a plurality of small segments, such as 2048 memory segments with a granularity of 1k.

Based on the above design of dividing the memory section into a plurality of memory segments, it is necessary to design a data structure that manages each memory segment. The data structure of this embodiment includes section metadata and total metadata.

This embodiment establishes metadata of each allocated memory section at a granularity of the memory section, which is called section metadata (header). The section metadata includes allocation status information of each memory segment in the allocated memory section. In a practical application, the data structure of the section metadata can be flexibly implemented as needed, and the allocation status information may also be implemented in various ways, which are not limited in this embodiment. It can be understood that section metadata needs to be established only for the memory section that has already been allocated, i.e., has stored data.

Exemplarily, each memory segment of the memory section can be numbered in a set order (such as in an order from a high order bit to a low order bit or from a low order bit to a high order bit, etc.), and each number can be configured with an allocation status tag indicating whether the memory segment is allocated. Or, a bitmap can be used to represent the allocation status of each memory segment in the memory section. The bitmap is a data structure, the bitmap includes at least one element, various elements are arranged in order, and “0” or “1” is used to indicate that a corresponding element of each element does not exist or exists. In this embodiment, each memory segment can be sorted in the set order, and two bits “0” or “1” can be used to indicate two statuses of whether the memory segment is allocated. Therefore, the allocation status information of each memory segment in one memory section can be represented through one bitmap, and the data occupation is low, which also facilitates the quick analysis of the occupancy of each segment in the memory section during subsequent processing. Of course, those skilled in the art are aware that various manners can be used to achieve the allocation status information in a practical application, and this embodiment does not limit this.

Exemplarily, the storage location of the section metadata may be in various ways, for example, the section metadata occupies a small amount of memory and may be stored in a memory segment of the memory section; the section metadata may occupy one or more memory segments according to the size of the section metadata and the size of the memory segment; and the memory segment for storing the section metadata may be configured according to the needs, for example, the section metadata may be stored starting from a first memory segment of the memory section or from a last memory segment of the memory section, etc. In other examples, the section metadata can also be stored uniformly in other locations in the memory, and this embodiment does not limit this.

In a reserved memory scenario, the memory can include a first storage space (unreserved memory) for use by an operating system of a computer device and a second storage space (reserved memory) for use by a virtual machine, where the second storage space includes the plurality of memory sections. The first storage space and the second storage space can adopt different management granularities, the first storage space can be managed by a first memory management module of the operating system, and the method of this embodiment can be applied to a second memory management module of the operating system used to manage the second storage space. If the second memory management module uses the first storage space, it needs to initiate memory allocation to the first memory management module. If the section metadata frequently changes, the second memory management module needs to interact frequently with the first memory management module. Based on this, the section metadata is stored in the memory segment of the memory section, and is directly managed by the second memory management module, which can improve processing efficiency. Moreover, the reserved memory section of the memory has a large granularity and are often not fully utilized, and the space occupied by the section metadata is also very limited, which does not affect the use of the memory section. There is no need to specially establish a corresponding relationship between the section metadata and the memory section, when the address of the memory section is determined, the section metadata of the memory section can be directly determined.

As an example, the size of the memory segment can be determined based on the size of the section metadata, and the size of the memory segment is enabled to be greater than or equal to the size of the section metadata, so that the section metadata is stored in one memory segment, such as the first memory segment, which can facilitate management and improve management efficiency.

Exemplarily, the section metadata also may include other information as needed, such as a physical address “paddr” (physics address) of the memory section ms, a number of free memory segments “free”, a maximum number of free segments (i.e., a maximum number of consecutive unallocated memory segments in the allocated memory section) “max_free”, and a serial number of a starting location of the maximal consecutively free segment “max”, etc., to facilitate subsequent allocation or release processing of the memory segment.

This embodiment also establishes total metadata, where the total metadata includes quantity information of an unallocated memory segment in each allocated memory section, which is used to determine an allocatable memory section in the memory.

The quantity information of the unallocated memory segment in each allocated memory section may include information related to each free memory segment in the allocated memory section, for example, a number of free memory segments and/or a maximum number of free segments, etc., where the maximum number of free segments characterizes a maximum number of consecutive free memory segments in the memory section. For example, in a certain memory section ms, there are 200 free memory segments, including two consecutive free memory segments, where the number of one consecutive free memory segments is 50, and the number of the other consecutive free memory segments is 150, the maximum number of free segments is 150. There are two types of allocated memory sections: a memory section with a free memory segment as in the example above; and a memory section fully occupied, that is, there is no free memory segments in the memory section, and the number of free memory segments is zero. When obtaining a memory allocation request through the above information, the total metadata can be used to quickly determine whether there is a memory section that meets the allocation request in the allocated memory section. In a practical application, the implementation of the data structure of the total metadata can be flexibly configured as needed, and this embodiment does not limit it.

Exemplarily, there can be multiple ways to store the total metadata. For example, in the reserved memory scenario, the total metadata can be stored in the unreserved storage space of the memory or in the reserved storage space of the memory. Exemplarily, due to the size of the total metadata and the need to reserve memory as much as possible for the virtual machine in the reserved memory scenario, the total metadata can be stored in an unreserved storage space.

In some example, the total metadata may include an address of each section metadata; after determining there is at least one alternative memory section that satisfies the memory allocation request, the method further includes: reading the section metadata of the at least one alternative memory section according to the address of the section metadata of the at least one alternative memory section. Therefore, this embodiment can quickly read the section metadata of the alternative memory section after the alternative memory section has been determined.

For the convenience of management and quick allocation, since there are two types of allocated memory sections, in some examples, information of a fully allocated memory section and information of an incompletely allocated memory section in the total metadata can be managed and stored separately.

In a practical application, the total metadata used to record the quantity information of an unallocated memory segment in each allocated memory section can be implemented in multiple ways. In some examples, a linked list can be used to store the quantity information of an unallocated memory segment in each allocated memory section in the total metadata.

The linked list is a physical storage structure that is discontinuous and non-sequential, and a logical order of data elements is achieved through the pointer linking order in the linked list. The linked list is composed of a series of nodes (each element in the linked list is called a node), the node can be dynamically generated at runtime. Each node includes two parts: a data field for storing data elements, and a pointer field for storing addresses.

The linked list includes a single linked list and a double linked list. As shown in FIG. 2B, it is a schematic diagram of a single linked list shown in the specification according to an embodiment. In the figure, the first node of the linked list includes a head pointer (head), whose data field is empty, and the head pointer (head) points to the data field of the next node. The back pointer (next) of the last node points to end (null). The end indicates that the linked list is a non-cyclic linked list. In other examples, the back pointer (next) of the last node can also point to the head pointer, thus forming a cyclic linked list.

The pointer field of each node in the double linked list includes a front pointer (prev) (used to point to the data field of the previous node) and a back pointer (next), thus, it is possible to quickly find the previous node of the current node compared to a single linked list. Similarly, according to the orientation of the back pointer (next) of the last node, the double linked list can also include non-cyclic and cyclic double linked lists. As shown in FIG. 2C, it is a schematic diagram of a double linked list shown in the specification according to an embodiment. In the figure, taking a cyclic double linked list as an example, the pointer field (i.e., a head pointer) of the first node includes a front pointer and a back pointer, and the data field (head) can be empty or store data as needed. Similarly, for other nodes, the pointer fields include a front pointer and a back pointer. The data fields in the figure are a1, a2, and a3 in sequence. For the sake of convenience in the figure, each node is shown in the form of a front pointer, a data field, and a back pointer in sequence. In a practical application, other manners can be used as needed, such as a front pointer, a back pointer, and a data field in sequence, and this embodiment does not limit it. In a practical application, the type of the double linked list can be selected as needed, and this embodiment does not limit it.

In some examples, the total metadata includes one or more first linked lists, and different first linked lists correspond to different quantity information. In a practical application, the first linked list can be a single linked list or a double linked list as needed, which is not limited in this embodiment.

The first linked list includes at least one node, and the node is used to store an address of the section metadata of the allocated memory section, so that the section metadata of the memory section can be quickly accessed through the total metadata. Where addresses of section metadata of allocated memory sections with the same quantity information are stored in different nodes of the first linked list.

As shown in FIG. 2D, there are two double linked lists: a linked list List_a and a linked list List_b. The linked list in this embodiment includes a head node. In a practical application, it is also optional to set the head node as needed, and this embodiment does not limit this.

The linked list List_a is a bidirectional cyclic linked list, where the pointer field (head pointer) of the first node includes a front pointer and a back pointer as well as data head_a. The front pointer points to the last node a1, and the back pointer points to the next node a1. Similarly, the front pointer of the node a1 points to head_a, and the back pointer points to head_a.

The linked list List_b is a bidirectional cyclic linked list, where the pointer field (head pointer) of the first node includes a front pointer and a back pointer as well as data head_b. The back pointer points to the next node b1, and the front pointer points to the last node b2. The orientations of the other two nodes are in a similar way, with reference to the accompanying drawing.

In the embodiment, the node can store the address of the section metadata (header) of the allocated memory section. As shown in the figure, a1, b1, and b2 respectively store the addresses of the section metadata (headers) the corresponding allocated memory section. The section metadata is stored in the memory segment of the memory section ms, such as the first memory segment, and the header of the memory section can be accessed through the node.

The node a1 in the linked list List-a is used to connect to the memory section m1. The nodes b1 and b2 in the linked list List-b respectively represent the memory sections m2 and m3, that is, the section metadata of m2 and the section metadata of m3 are linked in one linked list, which indicates that the two allocated memory sections have the same quantity information of the unallocated memory segment (such as max_free).

The section metadata of the allocated memory section corresponding to a1 and the section metadata of the allocated memory section corresponding to b1 adopt different linked lists, which indicates the quantity information of an unallocated memory segment of the allocated memory section corresponding to a1 (such as max_free) is different from the quantity information of an unallocated memory segment of the allocated memory section corresponding to b1 (such as max_free).

In a practical application, under the situation where there are a large number of memory segments, there are also many possibilities for quantity information of an unallocated memory segment in each allocated memory section. For example, a memory section has 2048 memory segments. When there are a plurality of memory sections, there are 2048 possibilities for the number of unallocated memory segments in the allocated memory sections. Each first linked list corresponds to quantity information of one unallocated memory segment, which means that there may be a plurality of first linked lists. In order to facilitate querying the available memory section through total metadata during memory allocation, in this embodiment, the total metadata includes a linked list array, and each element in the linked list array corresponds to a different quantity range; and each element is used to link to one or more of the first linked lists, and the quantity corresponding to the linked first linked list is within the quantity range corresponding to the element. Exemplarily, the linked list array in the total metadata can be separate metadata used to manage a linked list linked by each element in the array.

The quantity range can be divided according to the number of memory segments, there is a plurality of quantity ranges, and each quantity range can be the same or different. For example, there are 2048 memory segments that can be divided into 16 parts, with a quantity range from 1st to 128th, a quantity range from 129th to 256th, and so on. Those skilled in the art are aware that there are other various division manners in a practical application, and this embodiment does not limit this.

Based on this, n quantity ranges in number are divided, and there are n elements in the linked list array. Each element in a linked list array is a linked list. As an example, the linked list array partial[nlist] (where nlisit means there are n linked list elements) includes 16 elements: partial[0] to partial[15]. The first linked list with the unallocated memory segments ranging from “1″ to ”128″ is linked to the first element of the array, partial[0], and so on.

As shown in FIG. 2E, it is a schematic diagram of a linked list array shown in the specification according to an exemplary embodiment. The linked list array shown in FIG. 2E includes 16 elements, and the corresponding quantity range of each element is shown in the figure. For example, assuming that there are three allocated memory sections in the memory, according to the maximum number of free segments in the three allocated memory sections, the corresponding linked list can be:
assuming that the maximum number of free segments in the memory section ms1 is 100, the section metadata (header) of the memory section can be linked to the linked list List_a shown in FIG. 2D;
assuming that the maximum number of free segments, x_free, for both the memory section ms2 and the memory section ms3 is 120, the section metadata (header) of these two memory sections can be linked to the linked list List-b shown in FIG. 2D, where b1 represents the header of the memory section ms2, and b2 represents the header of the memory section ms3.

Since the maximum number of free segments of all the three memory sections is in the range of “1 to 128”, they can be linked to the first element of the array, partial[0].

In a practical application, multiple linking manners can be adapted as needed. For example, each element corresponds to a total linked list and is used to store the head pointer of the corresponding total linked list; and a head pointer of each first linked list is stored in a node of a total linked list corresponding to a corresponding element of the first linked list.

Each element in the linked list array is a linked list, and each element stores information that can be the first node of the linked list. For example, FIG. 2E shows the linked list array, and the information stored in the first element partial[0] is the first node information of the bidirectional cyclic linked list List_k. Specifically, the bidirectional cyclic linked list List_k linked by partial[0] includes: a node head_k, which points to the node k1, the node k1 points to the node k2, and next of k2 can points to head_k, thus forming the bidirectional cyclic linked list. That is, head_k, k1, and k2 form the linked list List_k; unlike the linked list List_k, the other two sets of linked lists, List_a and List_b, can be respectively linked to the linked list List_k. For example, the node k1 can store the first node of the linked list List_a, and the other node k2 can store the first node of the linked list List_b. As shown in FIG. 2F, k1 actually stores information of the first node of List_a framed by the dashed block in the figure, and k2 actually stores information of the first node of List_b framed by the dashed block in the figure, thereby achieving the linking between the linked list List_k, List_a, and the linked list List_b. For ease of understanding, the information within the dashed block has not been included in k1 and k2 in the figure.

Exemplarily, the above example involves two cases where the max free is 100 and 120. The max free can also be stored in the linked list as needed, for example, it can be stored in the data field head_a of the first node of List_a and the data field head b of the first node of List-b, respectively.

Exemplarily, the order of the two linked lists List_1 and List_2 linked by the linked list List_k can be flexibly configured as needed. For example, it can be sorted in ascending or descending order of the max_free, or in other custom order. This embodiment does not limit this.

Since there are multiple possibilities for the maximum number of memory segments max_free, the corresponding first linked list may be created in this embodiment only when max_free occurs. For example, in the range of “1 to 128” corresponding to the first element partial [0], since there are only two cases of max_free, namely 100 and 120, only the linked list List_a corresponding to 100 and the linked list List_b corresponding to 120 are created to reduce resource consumption. Correspondingly, the linked list List_k includes nodes used to link the two linked lists. It can be understood that in a practical application, a corresponding linked list can also be created for each max_free; and for a case where a certain max_free does not have a corresponding allocated memory section, the linked list corresponding to that max_free may also store a null value. This embodiment does not limit this.

In a practical application, there is a fully allocated memory section, i.e., all memory segments of the allocated memory section are allocated and the number of the free memory segment of the allocated memory section is zero. In this case, as mentioned earlier, similar to the previous example, a first linked list to representing that the number of the max free is zero can be created. In other examples, the fully allocated memory section can be managed separately. For example, another linked list can be created, which is referred to as a second linked list in this embodiment. The second linked list is not linked to the aforementioned first linked list in the linked list array. The data field of the node in the second linked list can be used to store an address of the section metadata of the fully allocated memory section, thereby linking the section metadata (header) of each fully allocated memory section, so that the section metadata (header) of each fully allocated memory section can be mounted in the same linked list. In the memory allocation scenario, there are no free memory segments in the fully allocated memory section, which cannot be used for allocation. Based on this, it achieves separate management of the fully allocated memory section and improves the processing efficiency of memory allocation.

As can be seen from the above embodiment, the elements in the linked list array may not be directly linked to the section metadata (header), and there is a layer of structural body (list) (i.e., each first linked list) in the middle, which may be allocated according to the maximum number of free segments as needed. For example, if the 1 to 128 corresponding to partial[0] only have one ms including 5 consecutive small segments, then it allocates it one linked list with a corresponding max_free of 5, and then this list is linked up to partial[0] and down to the header. The others whose maximum number of free segments have not yet appeared, so they are not allocated to avoid wasted metadata.

The above linked list data and the second linked list can be organized in a pool total structure, which serves as the total metadata that can be used to manage all the memory sections of the embodiment. In an implementation, the total metadata can also include other information, such as a record of a number nr of the contained memory section ms, a protection mark lock to protect an operation of the linked list, and a cache pool to cache list metadata and so on, which can be flexibly configured as needed in practice, and the embodiment does not limit this.

Based on the above metadata design, the specification also provides an embodiment of a memory management method. As shown in FIGS. 2G to 2H, they are flow charts of a memory management method shown in the specification according to an exemplary embodiment. The method may include the following steps.

Step 202, determining, according to the total metadata and the section metadata, a target memory segment with allocation status needing to be adjusted in response to a memory adjustment request.

Step 204, adjusting allocation status of the target memory segment based on a memory adjustment type corresponding to the memory adjustment request.

Step 206, after adjusting the allocation status of the target memory segment, updating allocation status information of section metadata of a target memory section to which the target memory segment belongs, and updating quantity information of an unallocated memory segment in the target memory section in the total metadata.

The memory management method of the embodiment can be applied to any scenario that requires memory management, including but not limited to the aforementioned reserved memory scenario. In some examples, the method of the embodiment can manage the entire storage space of the internal memory or a portion of the storage space thereof; for example, in the reserved memory scenario, a storage space in the internal memory reserved specifically for the virtual machine to use.

When applied to the reserved memory scenario, the memory can include a first storage space for use by an operating system of a computer device and a second storage space for use by the virtual machine, where the second storage space includes the plurality of memory sections. The first storage space and the second storage space can adopt different management units, the first storage space can be managed by a first memory management module of the operating system, and the method of this embodiment is applied to a second memory management module of the operating system used to manage the second storage space, that is, the solution of the embodiment can be used to manage the second storage space of the memory.

As shown in FIGS. 21 and 2J, the memory management usually involves two operations: memory allocation and memory release. These are respectively described next. Taking the method of the embodiment being applied to the memory management module as an example, in a practical application, the memory allocation and the memory release can be independent functions. The memory allocation request 21 is input to the memory management module, which can execute the step of determining the target memory segment 211 in step 211, as well as execute the step 212 of updating after adjusting the allocation status of the target memory segment, specifically including: the step of updating the section metadata of the target memory section and the step of updating the total metadata. Similarly, the memory release request 22 is input to the memory management module, which can execute the step of determining the target memory segment 221 in step 221, as well as execute the step 222 of updating after adjusting the allocation status of the target memory segment, specifically including: the step of updating the section metadata of the target memory section and the step of updating the total metadata.

In some examples, the memory adjustment request includes a memory allocation request; the determining, according to the total metadata and the section metadata, the target memory segment with allocation status needing to be adjusted includes:
determining, according to the total metadata, whether there is at least one alternative memory section that satisfies the memory allocation request;
if so, determining the target memory section in the at least one alternative memory section and the target memory segment used to allocate the memory in the target memory section according to section metadata corresponding to the at least one alternative memory section.

In this embodiment, the memory allocation request can carry a size of storage space to be allocated. In a practical application, the size of the storage space may be larger than or smaller than the size of one memory section. When it is less than the size of the memory section, the above-mentioned total metadata and section metadata can be used to determine whether there is a suitable free memory segment for allocation.

In some examples, the quantity information of the unallocated memory segment includes a maximum number of free segments, where the maximum number of free segments characterizes a maximum number of consecutive unallocated memory segments in the allocated memory section; and the determining whether there is at least one alternative memory section that satisfies the memory allocation request according to the total metadata includes:
determining a number of memory segments to be allocated required to satisfy the memory allocation request;
determining, according to the total metadata, whether there is at least one alternative memory section having a maximum number of free segments greater than or equal to the number of the memory segments to be allocated.

Exemplarily, the size of the storage space (size) can be divided by the size of the memory segment and rounded up to the nearest integer to obtain the number (chunk) of memory segments to be allocated.

Since the total metadata includes quantity information of an unallocated memory segment in each allocated memory section, it is possible to determine whether there is an allocatable memory section in the memory, and thus to query for the allocatable memory segment. In some examples, the quantity information of the unallocated memory segment recorded in the total metadata can be a number of free memory segments, and the storage space required for one memory allocation request, which can be a discontinuous memory segment.

In some other examples, the storage space required for one memory allocation request can be a contiguous memory segment. For example, the embodiment is based on the design of the maximum number of free segments, which can allocate the continuous target memory segment in response to each memory allocation request, thereby reducing the complexity of memory management. The total metadata stores the max free of each memory section, determines the quantity range to which the number (chunk) of the memory segment to be allocated belongs, and then queries the information stored in each element of the linked list array. The corresponding element being greater than or equal to the quantity range to which the chunk belongs is not empty, and there is a first linked list linked under the element, it can be determined that there is an available memory section.

In some examples, the determining the target memory section in the at least one alternative memory section and the target memory segment used to allocate the memory in the target memory section according to the section metadata corresponding to the at least one alternative memory section includes:
if there is an alternative memory section with a maximum number of free segments equal to the number of the memory segments to be allocated, determining, according to the section metadata of the alternative memory section, the alternative memory section and a maximum free segment in the alternative memory section to be the target memory section and the target memory segment used for allocation in the target memory section;
if the maximum number of free segments of the at least one alternative memory section all be greater than the number of the memory segments to be allocated, determining a difference between a number of consecutive unallocated memory segments in the alternative memory section and the number of the memory segments to be allocated according to the section metadata of the at least one alternative memory section, and determining, according to the difference, the target memory section and the target memory segment used for allocation in the target memory section.

In the embodiment, if there is a max_free, that is exactly equal to max_free of the memory segment chunk to be allocated, stored in the total metadata, one or more memory sections linked by the first linked list corresponding to max_free can be used as the target memory section. In a case of multiple memory sections, it is possible to flexibly select one of them as the target memory section as needed. For example, in order to facilitate updating metadata, the memory section to which the section metadata linked by a last node of the first linked list corresponding to max_free belongs can be used as the target memory section, so that the node can be quickly removed from the first linked list, thereby achieving the quick update of the total metadata.

If there is no max_free exactly equal to the memory segment chunk to be allocated, memory sections corresponding to other max_free can be selected as needed. For example, the memory segment chunk to be allocated is 110, and the max free includes 120, 150, 200, etc. in an ascending order, the allocated memory section corresponding to 120 can be selected, so as to minimize the fragmentation of the memory segments after the 120 memory segments of that memory section are allocated. Of course, it is also optional to select allocated memory sections corresponding to other max_free, and this embodiment does not limit it.

Taking an example of selecting each allocated memory section corresponding to max_free being 120 as an alternative memory section, there are a plurality of memory sections corresponding to max_free being 120; taking an example of two memory sections, the alternative memory section ms2 and the alternative memory section ms3 are included. Since the maximum numbers of contiguous free segments for ms2 and ms3 are greater than the memory segment chunk to be allocated, there may also be smaller contiguous free memory segments in ms2 and ms3 that may just match the chunk. In order to reduce the case of memory segment fragmentation, one of the memory sections can be selected as needed, the section metadata of which is traversed, and it can be determined whether there is a more suitable contiguous memory segment in the section metadata. Of course, in other examples, it is optional that selecting a plurality of memory sections or all memory sections and traversing the section metadata of each memory section, but such a manner may generate overhead when the system is busy, and can be flexibly configured as needed in a practical application, and the embodiment does not limit this. Exemplarily, taking an example of selecting m2, the section metadata of ms2 is read, the allocation status information of each memory segment therein is traversed, the section metadata of ms2 is read, the allocation status information of each memory segment therein is traversed, and finally the continuous free memory segment required to satisfy the chunk is determined. For example, through the section metadata of ms2, it is determined that there is also a consecutive free memory segment, the number of which is 115. Since the difference between 115 and the chunk is less than the difference between 118 and the chunk, ms2 is determined as the target memory segment, and the consecutive free memory segment of 115 found is determined as the target memory segment.

Based on this, the target memory segment in the determined target memory section is a memory section used for this allocation, and the address of the target memory segment can be returned to the request. And the allocation status of each target memory segment is adjusted from an unallocated status to an allocated status. Afterwards, the section metadata of the target memory section is updated, that is, the allocation status information of each memory segment of the target memory section is updated.

And, the quantity information of the unallocated memory segment in the target memory section in the total metadata is updated. For example, if the allocation status is adjusted, and the target memory section becomes a fully allocated memory section, the header of the target memory section is removed from the original first linked list and linked to the above second linked list representing the fully allocated memory section. If the maximum number of free segments in the target memory section changes, the header of the target memory section is removed from the original first linked list and a new maximum number of free segments is redetermined; where, if the original first linked list after removal is not linked to the header of the memory section, the original first linked list is deleted, i.e., linked list head metadata is deleted. If the new maximum number of free segments has a corresponding first linked list, it is added to the first linked list; if not, a first linked list is created and linked to the corresponding element in the linked list array.

Next, an embodiment of memory allocation is provided.

1. Receiving a memory allocation request, and determining the size of the storage space to be allocated; where the memory section that need to be allocated/the information of the memory section needs to be recorded in the total metadata pool; and the embodiment converts the size and granularity of the memory segment into the required number of memory segments chunk.

2. In the linked list array partial[] of the pool, checking whether there is a max free that satisfies the chunk; if so, obtaining the address information of the section metadata (header) of the target memory section according to the corresponding linked list, and returning the address information of the found header, going to step 5; otherwise, performing step 3.

3. Since all the free memory sections ms existing in the pool cannot meet the allocation requirements, reallocating a free memory section ms needs to be reallocated; if there is not enough memory space, the allocation failing and exiting directly, otherwise, performing step 4.

4. Allocating a new memory section ms, initializing the section metadata (header) of this memory section, and returning the address information of the header; and also, performing other related processes such as establishing a virtual address mapping, which will not be elaborated in this embodiment.

5. Determining the section metadata (header) that has been found and meets the allocation requirements according to the returned address information of the header; for a case where the max_free is equal to the required chunk, setting the starting allocation location sidx to a starting location (max) of the maximum contiguous small segment in the section metadata (header), and directly going to step 14.

6. Otherwise, if the max_free is greater than the required chunk (at that point, there may be a plurality of memory sections with the same max_free), traversing the allocation bitmap recorded in the header to find a location idx of the first free small segment.

7. Adding 1 to the number of continuous free segments, continue to determine whether the next small segment is free, if so, going to step 11, otherwise, going to step 8.

8. Determining whether the free segment (free) is equal to the required size of the chunk, if so, it indicates that the allocation requirement is met, directly going to step 13.

9. If the free segment (free) is larger than the chunk, recording the difference diff therebetween and comparing the difference with a minimum difference min_diff; if it is smaller than min_diff, recording the starting location min_idx of this continuous segment and updating min_diff.

10. Determining whether an end tag has been set, if yes, going to step 13; otherwise, going to step 11.

11. Continue to search for a starting location of the next free memory segment.

12. At this point, the next segment is still a free memory segment; determining whether the traversal has ended (if there are a plurality of memory sections with the same max_free, traversing the bitmap of one or more memory sections therefrom as needed), if so, setting an end tag, and going to step 8; otherwise, going back to step 7.

13. At this point, the minimum difference min_diff found is the required target memory segment, setting the allocation starting location sidx to min idx.

14. Setting the size of the starting chunk of the allocated location sidx to an allocated status.

15. Returning a virtual address (handle) where the sidx memory segment of the memory section is located, where this location can be used to store a small section of memory.

16. If it is not a newly allocated memory section, removing the address information of the memory section (header) from the existing linked list; and if the original linked list after removal is not linked to the header of the memory section, deleting the original first linked list, i.e., deleting linked list head metadata.

17. Determining the number of free memory segments in the header at this moment; if they are all full, moving them into a full linked list, and going to step 23; otherwise, going to step 18.

18. Since the memory section is not full, firstly updating the location (max) and size (max_free) of the maximum contiguous memory small segment in the header in the section metadata.

19. Searching, according to max_free, the location partial[i] of the not fully filled array where it is located.

20. Traversing the linked list head of the partial[i], and checking whether there is the linked list node of the max_free in the list below it; if no, performing step 21; otherwise, finding the list, and performing step 22.

21. Firstly allocating a linked list node (list) and setting its max_free value, and linking it upwards into partial[i].

22. Finding the list that satisfies max_free, and linking the header downwards into the list.

23. Completing the entire allocation process.

Next, an embodiment of memory release is provided. The memory adjustment request includes a memory release request, and the memory release request carries a size of memory to be released and an address of memory to be released; the determining, according to the total metadata and the section metadata, the target memory segment with allocation status needing to be adjusted includes: determining the target memory section according to a size of the memory section and the address of the memory to be released; determining a target memory segment to be released in the target memory section according to a size of the memory segment and the size of the memory to be released.

1. In response to a memory release request, removing a small section of memory out of the pool; determining the location (handler) to be released according to the memory release request, where a size of the handler is size; and converting, according to the size of the memory segment, it into the required number (chunk) of the allocated memory segment.

2. Determining the memory section where the handler is located according to the address of the handler, and accessing the section metadata (header) of this memory section.

3. Determining the location idx of the handler in the header according to the section metadata (header).

4. Setting the chunk of memory segments starting from idx to a free status.

5. Removing the header from the existing linked list; if the original linked list after removal is not linked to the header of the memory section, deleting the original linked list, i.e., deleting linked list head metadata.

6. Determining the number of free memory segments in the header at this moment; if they are all empty, releasing the memory section ms directly and returning it to the reserved memory management system of the previous level, and going to step 12; otherwise, performing step 7.

7. If they are not all full, updating the location (max) and size (max_free) of the maximum contiguous memory small segment in the header in this memory section ms.

8. Searching the location partial[i] of the element corresponding to the max free in the linked list array according to the max_free.

9. Traversing the linked list head of the partial[i], and checking whether there is the linked list node of the max_free in the list below it; if no, performing step 11; otherwise, finding the list, and performing step 10.

10. Firstly allocating a linked list node (list) and setting its max_free value, and linking it upwards into partial[i].

11. Finding the list that satisfies max_free, and linking the header downwards into the list.

12. Completing the entire allocation process.

Corresponding to the embodiments of the aforementioned memory management method, the specification also provides an embodiment of a memory management apparatus and a computer device to which it is applied.

The embodiment of the memory management apparatus in the specification can be applied to the computer device, such as a server or a terminal device. The apparatus embodiment can be achieved through software, or through hardware or a combination of software and hardware. Taking software implementation as an example, as a logical apparatus, it is formed by a processor where it is located reading the corresponding computer program instructions from a non-volatile memory into a memory and running them. From a hardware perspective, as shown in FIG. 3, it is a hardware structure diagram of the computer device where the memory management apparatus is located in the specification. In addition to a processor 310, a memory 330, a network interface 320, and a non-volatile memory 340 shown in FIG. 3, the computer device where the memory management apparatus 331 is located in the embodiment usually further includes other hardware according to the actual function of the computer device, which will not be repeated here.

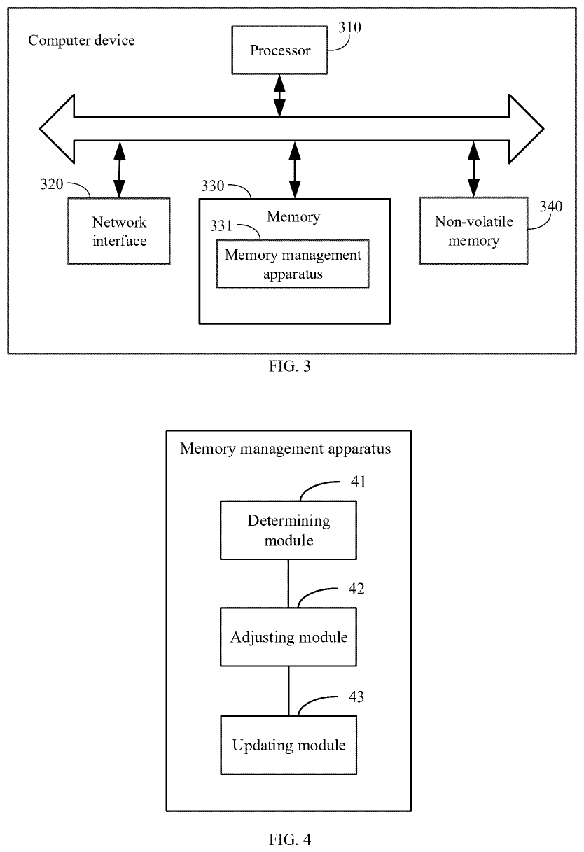

As shown in FIG. 4, FIG. 4 is a block diagram of a memory management apparatus shown in the specification according to an exemplary embodiment. Where the memory includes a plurality of memory sections, each memory section is divided into a plurality of memory segments;
the memory is used to store total metadata and section metadata corresponding to each allocated memory section;
the section metadata includes allocation status information of each memory segment in the allocated memory section;
the total metadata includes quantity information of an unallocated memory segment in each allocated memory section;
the apparatus includes:
a determining module 41, configured to determine, according to the total metadata and the section metadata, a target memory segment with allocation status needing to be adjusted in response to a memory adjustment request;
an adjusting module 42, configured to adjust allocation status of the target memory segment based on a memory adjustment type corresponding to the memory adjustment request;
an updating module 43, configured to, after adjusting the allocation status of the target memory segment, update allocation status information of section metadata of a target memory section to which the target memory segment belongs, and update quantity information of an unallocated memory segment in the target memory section in the total metadata.

In some examples, the memory adjustment request includes a memory allocation request;
the determining module 41 is further configured to:
determine, according to the total metadata, whether there is at least one alternative memory section that satisfies the memory allocation request;
if so, determine the target memory section in the at least one alternative memory section and the target memory segment used to allocate the memory in the target memory section according to section metadata corresponding to the at least one alternative memory section.

In some examples, the quantity information of the unallocated memory segment includes a maximum number of free segments, the maximum number of free segments characterizes a maximum number of consecutive unallocated memory segments in the allocated memory section;
the determining module 41 is further configured to:
determine a number of memory segments to be allocated required to satisfy the memory allocation request;
determine, according to the total metadata, whether there is at least one alternative memory section having a maximum number of free segments greater than or equal to the number of the memory segments to be allocated.

In some examples, the determining module 41 is further configured to:
if there is an alternative memory section with a maximum number of free segments equal to the number of the memory segments to be allocated, determine, according to the section metadata of the alternative memory section, the alternative memory section and a maximum free segment in the alternative memory section to be the target memory section and the target memory segment used for allocation in the target memory section;
if the maximum number of free segments of the at least one alternative memory section all be greater than the number of the memory segments to be allocated, determine a difference between a number of consecutive unallocated memory segments in the alternative memory section and the number of the memory segments to be allocated according to the section metadata of the at least one alternative memory section, and determine, according to the difference, the target memory section and the target memory segment used for allocation in the target memory section.

In some examples, the total metadata further includes an address of each section metadata; the determining module 41 is further configured to: after determining there is at least one alternative memory section that satisfies the memory allocation request, read the section metadata of the at least one alternative memory section according to the address of the section metadata of the at least one alternative memory section.

In some examples, the total metadata includes one or more first linked lists, and different first linked lists corresponds to different quantity information; the first linked list includes at least one node, each node is used to store an address of section metadata of the allocated memory section, so as to access the section metadata of the alternative memory section after determining the alternative memory section; where the addresses of the section metadata of the allocated memory sections with the same quantity information are stored in different nodes of the first linked list.

In some examples, the total metadata includes a linked list array, and each element in the linked list array corresponds to a different quantity range;

each element is used to link to one or more first linked lists, and the quantity information corresponding to the linked first linked list is within the quantity range corresponding to the element.

In some examples, each element corresponds to a total linked list and is used to store a head pointer of a corresponding total linked list;

a head pointer of each first linked list is stored in a node of a total linked list corresponding to a corresponding element of the first linked list.

In some examples, the memory adjustment request includes a memory release request, and the memory release request carries a size of memory to be released and an address of memory to be released;
the determining module 41 is further configured to:
determine the target memory section according to a size of the memory section and the address of the memory to be released;
determine a target memory segment to be released in the target memory section according to a size of the memory segment and the size of the memory to be released.

In some examples, the memory includes a first storage space for use by an operating system of a computer device and a second storage space for use by a virtual machine, the second storage space includes the plurality of memory sections;
the first storage space is managed by a first memory management module of the operating system, and the apparatus is applied to a second memory management module, of the operating system, used to manage the second storage space;
the section metadata of the allocated memory section is stored in the memory segment of the memory section, and the total metadata is stored in the first storage space through calling the first memory management module.

The implementation process of the functions and roles of each module in the above memory management apparatus is detailed in the implementation process of the corresponding steps in the above memory management method, and will not be repeated here.

Correspondingly, an embodiment of the specification also provides a computer program product, including a computer program which, when executed by a processor, implements steps of the embodiments of the aforementioned memory management method.

Correspondingly, an embodiment of the specification also provides a computer device, including a memory, a processor and a computer program stored in the memory and executable in the processor, where when executing the program, the processor implements steps of the embodiments of the memory management method.

Correspondingly, an embodiment of the specification also provides a computer readable storage medium, storing a computer program which, when executed by a processor, implements steps of the embodiments of the memory management method.

For the apparatus embodiment, since it basically corresponds to the method embodiment, it is sufficient to refer to a part of the description of the method embodiment where relevant. The above-described apparatus embodiments are only illustrative, where the modules described as separate components may or may not be physically separated, and the components displayed as modules may or may not be physical modules, i.e., they may be located in one place or distributed in multiple network modules, and some or all of the modules can be selected according to actual needs to achieve the purpose of the solution in the specification, which can be understood and implemented by those of ordinary skill in the art without creative effort.

The above embodiments can be applied to one or more electronic devices, the electronic device are devices capable of automatically performing numerical calculations and/or information processing according to preset or stored instructions. The hardware of the electronic device includes, but is not limited to, a microprocessor, an application specific integrated circuit (ASIC), a field-programmable gate array (FPGA), a digital signal processor (DSP), an embedded device, etc.

The electronic device can be any type of electronic product that can interact with a user through human-computer interaction, such as a personal computer, a tablet, a smartphone, a personal digital assistant (PDA), a game machine, an interactive internet protocol television (IPTV), a smart wearable device, etc.

The electronic device may also include a network device and/or a user device. Where the network device includes, but is not limited to, a single network server, a server group composed of multiple network servers, or a cloud, based on cloud computing, consisting of a large number of hosts or network servers.

The network where the electronic device is located includes but is not limited to Internet, a wide area network, a metropolitan area network, a local area network, a virtual private network (VPN), etc.

The specific embodiments of the specification have been described above. Other embodiments are within the scope of the appended claims. In some cases, the actions or steps described in the claims may be performed in a different order than in the embodiments and still achieve the desired results. In addition, the process depicted in the accompanying drawings does not necessarily require only the specific or continuous order shown to achieve the desired results. In some implementations, multitasking and parallel processing are also possible or may be advantageous.

The step division of the various methods mentioned above is only for the purpose of clear description. During implementation, they can be merged into one step or some steps can be split and decomposed into multiple steps. As long as they include the same logical relationship, they are within the scope of protection of the present application. Adding irrelevant modifications or introducing irrelevant designs to algorithms or processes without altering their core design is within the protection scope of the present application.

Where the description of “specific examples” or “some examples” means that the specific features, structures, materials, or characteristics described in conjunction with embodiments or examples are included in at least one embodiment or example of the specification. In the specification, the illustrative expressions of the above terms may not necessarily refer to the same embodiments or examples. Moreover, the specific features, structures, materials, or characteristics described can be combined in a suitable manner in any one or more embodiments or examples.

After considering the specification and practicing the invention applied here, those skilled in the art will easily come up with other implementation solutions of the specification. The specification is intended to cover any variations, uses, or adaptive changes of the specification, these variations, uses, and adaptive changes follow general principles of the specification and include common knowledge or customary technical means in the technical field that have not been applied for in the specification. The specification and embodiments are only considered as exemplary, and the true scope and spirit of the specification are indicated by the following claims.

It should be understood that the specification is not limited to the precise structure described above and shown in the accompanying drawings, and various modifications and changes can be made without departing from its scope. The scope of the specification is limited only by the claims attached.

The above are only preferred embodiments of the specification and are not intended to limit the specification. Any modifications, equivalent replacements, improvements, etc. made within the spirit and principle of the specification shall be included within the protection scope of the specification.

1. A memory management method, wherein a memory comprises a plurality of memory sections, each memory section is divided into a plurality of memory segments;
the memory is used to store total metadata and section metadata corresponding to each allocated memory section;
the section metadata comprises allocation status information of each memory segment in the allocated memory section;
the total metadata comprises quantity information of an unallocated memory segment in each allocated memory section;
the method comprises:
determining, according to the total metadata and the section metadata, a target memory segment with allocation status needing to be adjusted in response to a memory adjustment request;
adjusting allocation status of the target memory segment based on a memory adjustment type corresponding to the memory adjustment request;
after adjusting the allocation status of the target memory segment, updating allocation status information of section metadata of a target memory section to which the target memory segment belongs, and updating quantity information of an unallocated memory segment in the target memory section in the total metadata.

2. The method according to claim 1, wherein the memory adjustment request comprises a memory allocation request;
the determining, according to the total metadata and the section metadata, the target memory segment with allocation status needing to be adjusted comprises:
determining, according to the total metadata, whether there is at least one alternative memory section that satisfies the memory allocation request;
if so, determining the target memory section in the at least one alternative memory section and the target memory segment used to allocate the memory in the target memory section according to section metadata corresponding to the at least one alternative memory section.

3. The method according to claim 2, wherein the quantity information of the unallocated memory segment comprises a maximum number of free segments, the maximum number of free segments characterizes a maximum number of consecutive unallocated memory segments in the allocated memory section;
the determining whether there is at least one alternative memory section that satisfies the memory allocation request according to the total metadata comprises:
determining a number of memory segments to be allocated required to satisfy the memory allocation request;
determining, according to the total metadata, whether there is at least one alternative memory section having a maximum number of free segments greater than or equal to the number of the memory segments to be allocated.

4. The method according to claim 3, wherein the determining the target memory section in the at least one alternative memory section and the target memory segment used to allocate the memory in the target memory section according to the section metadata corresponding to the at least one alternative memory section comprises:
if there is an alternative memory section with a maximum number of free segments equal to the number of the memory segments to be allocated, determining, according to the section metadata of the alternative memory section, the alternative memory section and a maximum free segment in the alternative memory section to be the target memory section and the target memory segment used for allocation in the target memory section;
if the maximum number of free segments of the at least one alternative memory section all be greater than the number of the memory segments to be allocated, determining a difference between a number of consecutive unallocated memory segments in the alternative memory section and the number of the memory segments to be allocated according to the section metadata of the at least one alternative memory section, and determining, according to the difference, the target memory section and the target memory segment used for allocation in the target memory section.

5. The method according to claim 2, wherein the total metadata further comprises an address of each section metadata; after determining there is at least one alternative memory section that satisfies the memory allocation request, the method further comprises: reading the section metadata of the at least one alternative memory section according to the address of the section metadata of the at least one alternative memory section.

6. The method according to claim 5, wherein the total metadata comprises one or more first linked lists, and different first linked lists corresponds to different quantity information;
the first linked list comprises at least one node, each node is used to store an address of section metadata of the allocated memory section, so as to access the section metadata of the alternative memory section after determining the alternative memory section; wherein the addresses of the section metadata of the allocated memory sections with the same quantity information are stored in different nodes of the first linked list.

7. The method according to claim 6, wherein the total metadata comprises a linked list array, and each element in the linked list array corresponds to a different quantity range;
each element is used to link to one or more first linked lists, and the quantity information corresponding to the linked first linked list is within the quantity range corresponding to the element.

8. The method according to claim 7, wherein each element corresponds to a total linked list and is used to store a head pointer of a corresponding total linked list;
a head pointer of each first linked list is stored in a node of a total linked list corresponding to a corresponding element of the first linked list.

9. The method according to claim 1, wherein the memory adjustment request comprises a memory release request, and the memory release request carries a size of memory to be released and an address of memory to be released;
the determining, according to the total metadata and the section metadata, the target memory segment with allocation status needing to be adjusted comprises:
determining the target memory section according to a size of the memory section and the address of the memory to be released;
determining a target memory segment to be released in the target memory section according to a size of the memory segment and the size of the memory to be released.

10. The method according to claim 1, wherein the memory comprises a first storage space for use by an operating system of a computer device and a second storage space for use by a virtual machine, the second storage space comprises the plurality of memory sections;
the first storage space is managed by a first memory management module of the operating system, and the method is applied to a second memory management module, of the operating system, used to manage the second storage space;
the section metadata of the allocated memory section is stored in the memory segment of the memory section, and the total metadata is stored in the first storage space through calling the first memory management module.

11. A memory management apparatus, wherein a memory comprises a plurality of memory sections, each memory section is divided into a plurality of memory segments;
the memory is used to store total metadata and section metadata corresponding to each allocated memory section;
the section metadata comprises allocation status information of each memory segment in the allocated memory section;
the total metadata comprises quantity information of an unallocated memory segment in each allocated memory section;
the apparatus comprises:
a memory, a processor, and a computer program stored in the memory and running in the processor, wherein when executing the computer program, the processor is configured to:
determine, according to the total metadata and the section metadata, a target memory segment with allocation status needing to be adjusted in response to a memory adjustment request;
adjust allocation status of the target memory segment based on a memory adjustment type corresponding to the memory adjustment request;
after adjusting the allocation status of the target memory segment, update allocation status information of section metadata of a target memory section to which the target memory segment belongs, and update quantity information of an unallocated memory segment in the target memory section in the total metadata.

12. (canceled)

13. A non-transitory computer readable storage medium, storing a computer program which, when executed by a processor, implements a memory management, wherein a memory comprises a plurality of memory sections, each memory section is divided into a plurality of memory segments; the memory is used to store total metadata and section metadata corresponding to each allocated memory section;
the section metadata comprises allocation status information of each memory segment in the allocated memory section;
the total metadata comprises quantity information of an unallocated memory segment in each allocated memory section;
wherein the processor is specifically configured to implement the following:
determining, according to the total metadata and the section metadata, a target memory segment with allocation status needing to be adjusted in response to a memory adjustment request;
adjusting allocation status of the target memory segment based on a memory adjustment type corresponding to the memory adjustment request;
after adjusting the allocation status of the target memory segment, updating allocation status information of section metadata of a target memory section to which the target memory segment belongs, and updating quantity information of an unallocated memory segment in the target memory section in the total metadata.

14. The apparatus according to claim 11, wherein the memory adjustment request comprises a memory allocation request;
when determining, according to the total metadata and the section metadata, the target memory segment with allocation status needing to be adjusted, the processor is specifically configured to:
determine, according to the total metadata, whether there is at least one alternative memory section that satisfies the memory allocation request;
if so, determine the target memory section in the at least one alternative memory section and the target memory segment used to allocate the memory in the target memory section according to section metadata corresponding to the at least one alternative memory section.

15. The apparatus according to claim 14, wherein the quantity information of the unallocated memory segment comprises a maximum number of free segments, the maximum number of free segments characterizes a maximum number of consecutive unallocated memory segments in the allocated memory section;
when determining whether there is at least one alternative memory section that satisfies the memory allocation request according to the total metadata, the processor is specifically configured to:
determine a number of memory segments to be allocated required to satisfy the memory allocation request;
determine, according to the total metadata, whether there is at least one alternative memory section having a maximum number of free segments greater than or equal to the number of the memory segments to be allocated.

16. The apparatus according to claim 15, wherein when determining the target memory section in the at least one alternative memory section and the target memory segment used to allocate the memory in the target memory section according to the section metadata corresponding to the at least one alternative memory section, the processor is specifically configured to:
if there is an alternative memory section with a maximum number of free segments equal to the number of the memory segments to be allocated, determine, according to the section metadata of the alternative memory section, the alternative memory section and a maximum free segment in the alternative memory section to be the target memory section and the target memory segment used for allocation in the target memory section;
if the maximum number of free segments of the at least one alternative memory section all be greater than the number of the memory segments to be allocated, determine a difference between a number of consecutive unallocated memory segments in the alternative memory section and the number of the memory segments to be allocated according to the section metadata of the at least one alternative memory section, and determine, according to the difference, the target memory section and the target memory segment used for allocation in the target memory section.

17. The apparatus according to claim 14, wherein the total metadata further comprises an address of each section metadata; after determining there is at least one alternative memory section that satisfies the memory allocation request, the processor is further configured to: read the section metadata of the at least one alternative memory section according to the address of the section metadata of the at least one alternative memory section.

18. The apparatus according to claim 17, wherein the total metadata comprises one or more first linked lists, and different first linked lists corresponds to different quantity information;
the first linked list comprises at least one node, each node is used to store an address of section metadata of the allocated memory section, so as to access the section metadata of the alternative memory section after determining the alternative memory section; wherein the addresses of the section metadata of the allocated memory sections with the same quantity information are stored in different nodes of the first linked list.

19. The apparatus according to claim 18, wherein the total metadata comprises a linked list array, and each element in the linked list array corresponds to a different quantity range;
each element is used to link to one or more first linked lists, and the quantity information corresponding to the linked first linked list is within the quantity range corresponding to the element.

20. The apparatus according to claim 19, wherein each element corresponds to a total linked list and is used to store a head pointer of a corresponding total linked list;
a head pointer of each first linked list is stored in a node of a total linked list corresponding to a corresponding element of the first linked list.

21. The apparatus according to claim 11, wherein the memory adjustment request comprises a memory release request, and the memory release request carries a size of memory to be released and an address of memory to be released;
when determining, according to the total metadata and the section metadata, the target memory segment with allocation status needing to be adjusted, the processor is specifically configured to:
determine the target memory section according to a size of the memory section and the address of the memory to be released;
determine a target memory segment to be released in the target memory section according to a size of the memory segment and the size of the memory to be released.
